(19) United States
(12) Patent Application Publication
(10) Pub. No.: US 2025/0223910 A1
(43) Pub. Date: Jul. 10, 2025

(54) GAS TURBINE STATIONARY BLADE AND GAS TURBINE

(71) Applicant: MITSUBISHI HEAVY INDUSTRIES, LTD., Tokyo (JP)

(72) Inventors: Shinichi HIGUCHI, Tokyo (JP); Takeshi ASO, Tokyo (JP); Yasuhiro HORIUCHI, Tokyo (JP); Kota KAWAMURA, Tokyo (JP); Eiichi KOBAYASHI, Tokyo (JP); Hironori TSUKIDATE, Tokyo (JP); Ryota NAKATA, Tokyo (JP); Kai NAKAYAMA, Tokyo (JP); Noboru OKUYAMA, Tokyo (JP); Tadashi MURAKATA, Tokyo (JP); Shosaku HIWATASHI, Tokyo (JP)

(21) Appl. No.: 18/879,439

(22) PCT Filed: May 24, 2023
(86) PCT No.: PCT/JP2023/019344

§ 371 Date: Dec. 27, 2024

(30) Foreign Application Priority Data
Jul. 19, 2022 (JP) 2022-114636

(51) Int. Cl. F01D 9/06; F01D 25/14

(52) U.S. Cl. CPC F01D 9/065; F01D 25/145; F05D 2240/15; F05D 2260/201

(57) ABSTRACT

A gas turbine stationary blade including: a path that passes through the inside of a blade shape part so as to connect an outer cavity, which is formed on the outer side of an outer shroud in the blade height direction, and an inner cavity, which is formed on the inner side of an inner shroud in the blade height direction; a sealed tube that is provided in the path and that is configured to guide the air in the outer cavity to the inner cavity; a fixed plate that is attached to the sealed tube and that is fixed to the outer shroud; and a heat-shielding plate that is disposed on the outer side of the fixed plate in the blade height direction and that is disposed to cover at least a portion of the outer shroud.

### TECHNICAL FIELD

The present disclosure relates to a gas turbine stator vane and a gas turbine.

The present application claims the benefit of priority based on Japanese Patent Application No. 2022-114636 filed to the Japanese Patent Office on Jul. 19, 2022, the content of which is incorporated herein by reference.

### BACKGROUND ART

In the gas turbine according to PTL 1, an outer side cavity is formed between a gas turbine stator vane and a turbine casing, and cooling air guided to the outer side cavity is guided to an inner peripheral side of the gas turbine stator vane (an inner side of the gas turbine in a radial direction) through a tube disposed in a passage formed inside the gas turbine stator vane, and the cooling air is used for cooling a rotor shaft on the inner peripheral side of the gas turbine stator vane. In this configuration, the cooling air is guided to the inner peripheral side of the gas turbine through the tube disposed in the internal passage of the gas turbine stator vane. Thus, an increase in a temperature of the cooling air because of heat input through convection and radiation from a wall surface of the internal passage of the gas turbine stator vane is suppressed by the tube. This can suppress a decrease in cooling capacity of the cooling air.

### CITATION LIST

### Patent Literature

[PTL 1] Japanese Unexamined Patent Application Publication No. 2017-187040

### SUMMARY OF INVENTION

### Technical Problem

The gas turbine stator vane is provided with an outer side shroud connected to an outer side of a vane-shaped portion in a vane height direction and an inner side shroud connected to an inner side of the vane-shaped portion in the vane height direction. In a case where the temperature of the cooling air in the outer side cavity facing the outer side shroud is increased during an operation of the gas turbine because of heat input from the outer side shroud, the cooling capacity of the cooling air is decreased. In addition, in a case where the temperature of the cooling air in the inner side cavity facing the inner side shroud is increased during the operation of the gas turbine because of heat input from the inner side shroud, the cooling capacity of the cooling air is decreased. Regarding this point, PTL 1 does not disclose any findings related to such a problem and its solution.

In view of the above circumstances, an object of at least one embodiment of the present disclosure is to provide a gas turbine stator vane and a gas turbine capable of suppressing an increase in a temperature of cooling air.

### Solution to Problem

In order to achieve the object, a gas turbine stator vane according to at least one embodiment of the present disclosure is provided with a vane-shaped portion, an outer side shroud connected to an outer side of the vane-shaped portion in a vane height direction, an inner side shroud connected to an inner side of the vane-shaped portion in the vane height direction, a passage passing through an inside of the vane-shaped portion to provide communication between an outer side cavity formed on an outer side of the outer side shroud in the vane height direction and an inner side cavity formed on an inner side of the inner side shroud in the vane height direction, a sealed tube that is disposed in the passage and that is configured to guide air in the outer side cavity to the inner side cavity, a fixed plate attached to the sealed tube and fixed to the outer side shroud, and a heat shield plate that is disposed on an outer side of the fixed plate in the vane height direction and that is disposed to cover at least a part of the outer side shroud, in which, in a case where a projection area in which the outer side shroud is projected to a plane orthogonal to the vane height direction is denoted by A, and a projection area in which the heat shield plate is projected to a plane orthogonal to the vane height direction is denoted by B, B/A≥0.40 is satisfied.

In order to achieve the object, a gas turbine stator vane according to at least one embodiment of the present disclosure is provided with a vane-shaped portion, an outer side shroud connected to an outer side end of the vane-shaped portion in a vane height direction, an inner side shroud connected to an inner side end of the vane-shaped portion in the vane height direction, a passage passing through an inside of the vane-shaped portion to provide communication between an outer side cavity formed on an outer side of the outer side shroud in the vane height direction and an inner side cavity formed on an inner side of the inner side shroud in the vane height direction, a sealed tube that is disposed in the passage and that is configured to guide air in the outer side cavity to the inner side cavity, a fixed plate attached to the sealed tube and fixed to the inner side shroud, and a heat shield plate that is disposed on an inner side of the fixed plate in the vane height direction and that is disposed to cover at least a part of the inner side shroud.

In order to achieve the object, a gas turbine according to at least one embodiment of the present disclosure is provided with the gas turbine stator vane, a turbine rotor, and a turbine casing accommodating the turbine rotor.

### Advantageous Effects of Invention

According to at least one embodiment of the present disclosure, a gas turbine stator vane and a gas turbine capable of suppressing an increase in a temperature of cooling air are provided.

### BRIEF DESCRIPTION OF DRAWINGS

FIG. 1 is a diagram illustrating a schematic configuration of a gas turbine 2 according to one embodiment.

FIG. 2 is a diagram illustrating an example of a cross section taken along a vane height direction in a turbine stator vane 12 of the gas turbine 2.

FIG. 3 is an enlarged view of an end portion of the turbine stator vane 12 on an outer side in the vane height direction in the cross section illustrated in FIG. 2.

FIG. 4 is a diagram in which an outer side shroud 22 of the turbine stator vane 12 is seen from the outer side in the vane height direction along the vane height direction.

FIG. 5 is a diagram in which the outer side shroud 22 of the turbine stator vane 12 is seen from the outer side in the vane height direction along the vane height direction.

FIG. 6 is a diagram in which the outer side shroud 22 of the turbine stator vane 12 is seen from the outer side in the vane height direction along the vane height direction.

FIG. 7 is a diagram in which the outer side shroud 22 of the turbine stator vane 12 is seen from the outer side in the vane height direction along the vane height direction.

FIG. 8 is a diagram in which the outer side shroud 22 of the turbine stator vane 12 is seen from the outer side in the vane height direction along the vane height direction.

FIG. 9 is a diagram in which the outer side shroud 22 of the turbine stator vane 12 is seen from the outer side in the vane height direction along the vane height direction.

FIG. 10 is a diagram in which the outer side shroud 22 of the turbine stator vane 12 is seen from the outer side in the vane height direction along the vane height direction.

FIG. 11 is a diagram in which the outer side shroud 22 of the turbine stator vane 12 is seen from the outer side in the vane height direction along the vane height direction.

FIG. 12 is a diagram illustrating a modification example of the turbine stator vane 12 illustrated in FIG. 2 and is a diagram illustrating another example of the cross section taken along the vane height direction in the turbine stator vane 12.

FIG. 13 is an enlarged view of an end portion of the turbine stator vane 12 illustrated in FIG. 12 on an inner side in the vane height direction.

FIG. 14 is a diagram for describing a configuration of the end portion of the turbine stator vane 12 illustrated in FIG. 13 on the inner side in the vane height direction.

### DESCRIPTION OF EMBODIMENTS

Hereinafter, several embodiments of the present disclosure will be described with reference to the accompanying drawings. Dimensions, materials, shapes, relative disposition, and the like of constituents described as the embodiments or illustrated in the drawings are not intended to limit the scope of the invention thereto but are merely simple descriptive examples.

For example, expressions such as “in a certain direction”, “along a certain direction”, “parallel”, “orthogonal”, “center”, “concentric”, or “coaxial” representing relative or absolute disposition not only represent such disposition in a strict sense but also represent a state of relative displacement with allowance or with an angle or a distance to an extent in which the same function is obtained.

For example, expressions such as “identical”, “equal”, and “homogeneous” representing a state of equality between objects not only represent a state of equality in a strict sense but also represent a state where allowance or a difference to an extent in which the same function is obtained is present.

For example, expressions representing shapes such as a quadrangular shape and a cylindrical shape not only represent shapes such as a quadrangular shape and a cylindrical shape in a geometrically strict sense but also represent shapes including a rough portion, a chamfered portion, and the like within a scope in which the same effect is obtained.

Meanwhile, expressions such as “provided with”, “furnished with”, “equipped with”, “including”, or “having” one constituent are not exclusive expressions that exclude presence of other constituents.

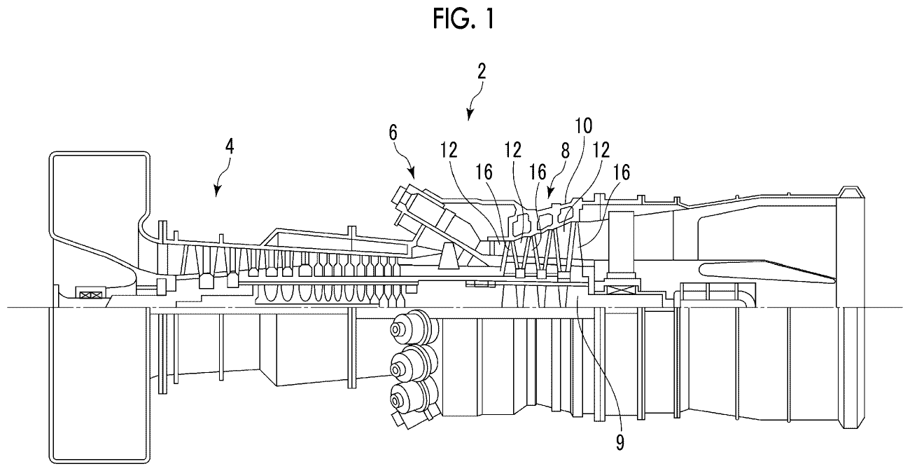

FIG. 1 is a diagram illustrating a schematic configuration of a gas turbine 2 according to one embodiment.

As illustrated in FIG. 1, the gas turbine 2 is provided with a compressor 4, a combustor 6 for combusting a mixture of compressed air generated by the compressor 4 and fuel, and a turbine 8 for obtaining power from combustion gas generated by the combustor 6.

As illustrated in FIG. 1, the turbine 8 includes a rotor 9 (a turbine rotor), a turbine casing 10 accommodating the rotor 9, a plurality of turbine stator vanes 12 (gas turbine stator vanes) fixed to an inner surface of the turbine casing 10, and a plurality of turbine rotor vanes 16 attached to the rotor 9 to be alternately arranged in an axial direction with respect to the turbine stator vanes 12. In the following description, the term “circumferential direction” means a circumferential direction of the gas turbine 2, that is, a circumferential direction of the rotor 9, unless otherwise specified. The term “axial direction” means an axial direction of the gas turbine 2, that is, an axial direction of the rotor 9, unless otherwise specified. The term “radial direction” means a radial direction of the gas turbine 2, that is, a radial direction of the rotor 9, unless otherwise specified.

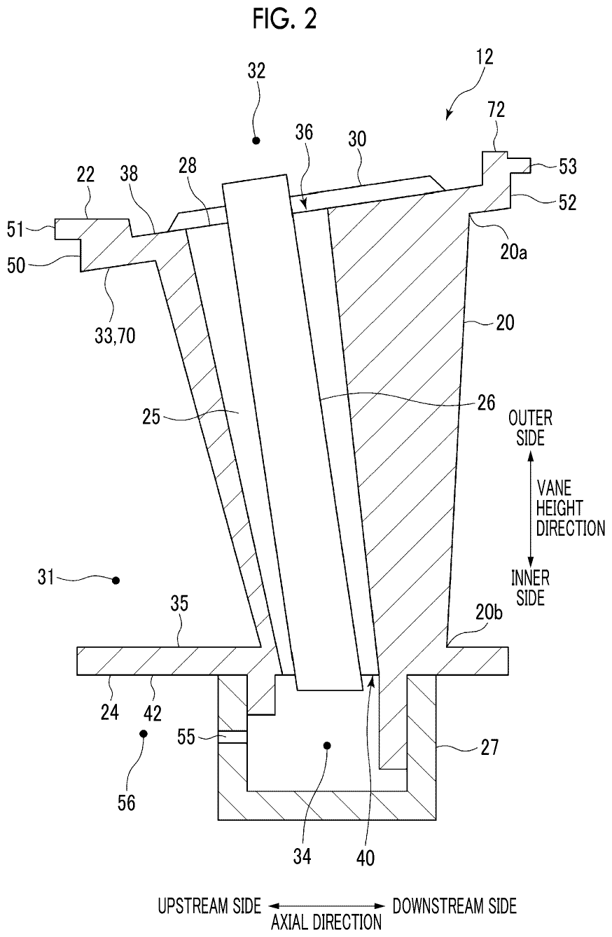

FIG. 2 is a diagram illustrating an example of a cross section taken along a vane height direction in the turbine stator vane 12.

As illustrated in FIG. 2, the turbine stator vane 12 includes a vane-shaped portion 20, an outer side shroud 22, an inner side shroud 24, a passage 25, a sealed tube 26, a fixed plate 28, and a heat shield plate 30. In the present specification, the term “vane height direction” is a vane height direction of the turbine stator vane 12, that is, a vane height direction of the vane-shaped portion 20, and means the radial direction of the gas turbine 2.

The vane-shaped portion 20 has a cross-sectional shape of a vane shape defined by a pressure surface and a suction surface. The passage 25 that provides communication between an outer side cavity 32 formed on an outer side of the outer side shroud 22 in the vane height direction and an inner side cavity 34 formed on an inner side of the inner side shroud 24 in the vane height direction is formed inside the vane-shaped portion 20. The outer side cavity 32 is a space formed between the outer side shroud 22 and the turbine casing 10 (refer to FIG. 1), and the inner side cavity 34 is a space formed between the inner side shroud 24 and an inner peripheral side diaphragm 27.

The outer side shroud 22 is connected to an outer side end 20a of the vane-shaped portion 20 in the vane height direction and is formed to have a substantially plate shape along a surface intersecting with the vane height direction. The outer side shroud 22 forms an outer peripheral wall 33 of a flow channel 31 of combustion gas in the turbine 8 (a flow channel of a main flow of the combustion gas in the turbine 8). A hook 51 protruding to an upstream side in the axial direction is formed on an end surface 50 of the outer side shroud 22 on the upstream side in the axial direction, and a hook 53 protruding to a downstream side in the axial direction is formed on an end surface 52 of the outer side shroud 22 on the downstream side in the axial direction. The turbine stator vane 12 is fixed to the turbine casing 10 by engaging the hook 51 and the hook 53 with grooves (not illustrated), respectively, formed on the inner surface of the turbine casing 10. In the present specification, the term “upstream side in the axial direction” means an upstream side of the main flow of the combustion gas of the turbine 8 (a flow of the combustion gas flowing through the flow channel 31) in the axial direction, and the term “downstream side in the axial direction” means a downstream side of the main flow of the combustion gas of the turbine 8 (a flow of the combustion gas flowing through the flow channel 31) in the axial direction.

The inner side shroud 24 is connected to an inner side end 20b of the vane-shaped portion 20 in the vane height direction and is formed to have a substantially plate shape along a surface intersecting with the vane height direction. The inner side shroud 24 forms an inner peripheral wall 35 of the flow channel 31 of the combustion gas in the turbine 8 (the flow channel of the main flow of the combustion gas in the turbine 8). The inner peripheral side diaphragm 27 of an annular shape disposed on an inner peripheral side of the inner side shroud 24 is fixed to the inner side shroud 24.

The passage 25 passes through an inside the vane-shaped portion 20 to provide communication between the outer side cavity 32 formed on the outer side of the outer side shroud 22 in the vane height direction and the inner side cavity 34 formed on the inner side of the inner side shroud 24 in the vane height direction. An inlet 36 of the passage 25 is formed on a wall surface 38 of the outer side shroud 22 on an outer side in the vane height direction, and an outlet 40 of the passage 25 is formed on a wall surface 42 of the inner side shroud 24 on an inner side in the vane height direction.

The sealed tube 26 is configured to have a tube shape and is disposed in the passage 25 along a direction in which the passage 25 extends (an axis line direction of the passage 25). The sealed tube 26 is configured to guide air in the outer side cavity 32 to the inner side cavity 34 on the inner side of the inner side shroud 24 in the vane height direction.

The compressed air from the compressor 4 is supplied to the outer side cavity 32 as cooling air. The cooling air that has entered the sealed tube 26 from the outer side cavity 32 is supplied to an inter-stage space 56 (a disc cavity) between the turbine stator vane 12 and the turbine rotor vane 16 (refer to FIG. 1) adjacent to an upstream side of the turbine stator vane 12 through holes 55 formed in the inner side cavity 34 and the inner peripheral side diaphragm 27, and functions as cooling air.

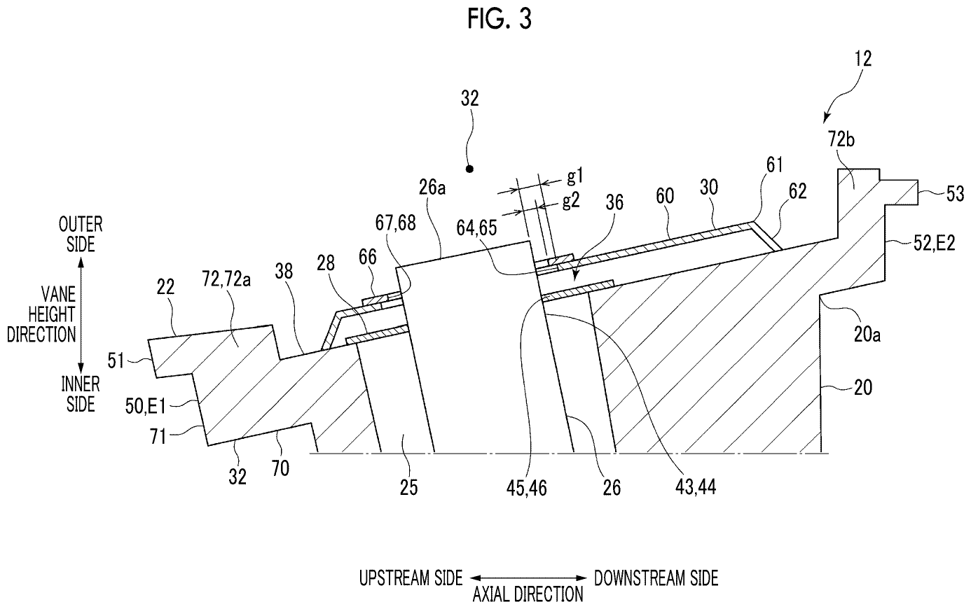

FIG. 3 is an enlarged view of an end portion of the turbine stator vane 12 illustrated in FIG. 2 on the outer side in the vane height direction.

As illustrated in FIG. 3, the fixed plate 28 is attached to the outer peripheral surface 44 of an end portion 43 of the sealed tube 26 on the outer side in the vane height direction and fixed to the outer peripheral surface 44. The sealed tube 26 is provided to pass through a through-hole 45 formed in a center portion of the fixed plate 28, and the outer peripheral surface 44 of the sealed tube 26 and an inner surface 46 of the through-hole 45 are joined to each other by, for example, welding. The fixed plate 28 is disposed on the wall surface 38 of the outer side shroud 22 on the outer side in the vane height direction to close a part of the inlet 36 of the passage 25 on an outer side of the sealed tube 26, and is fixed to the wall surface 38.

The heat shield plate 30 is disposed on an outer side of the fixed plate 28 in the vane height direction. The heat shield plate 30 is disposed at a gap from the fixed plate 28 in the vane height direction. In the illustrated example, the heat shield plate 30 includes a top plate portion 60 disposed parallel to each of the wall surface 38 and the fixed plate 28 at a gap from each of the fixed plate 28 and the wall surface 38 in the vane height direction, and a side wall portion 62 that is connected to a peripheral edge 61 of the top plate portion 60 and that is provided to surround the sealed tube 26 and the fixed plate 28. A gap g1 is provided between the heat shield plate 30 and the sealed tube 26. In the illustrated example, a through-hole 64 through which the sealed tube 26 passes is formed in the heat shield plate 30, and the gap g1 is provided between an inner surface 65 of the through-hole 64 and the outer peripheral surface 44 of the sealed tube 26 over the entire periphery of the sealed tube 26. An impingement cooling hole for impingement cooling of the wall surface 38 of the outer side shroud 22 is not formed in the heat shield plate 30. From a viewpoint of suppressing an increase in a temperature of the cooling air to be provided into the sealed tube 26, an outer side end 26a of the sealed tube 26 in the vane height direction is preferably positioned on an outer side of the heat shield plate 30 in the vane height direction. However, the outer side end 26a of the sealed tube 26 may be present at the same position as the heat shield plate 30 or on an inner side of the heat shield plate 30 in the vane height direction.

In the illustrated exemplary embodiment, a gap adjustment plate 66 is disposed on the heat shield plate 30, and a through-hole 67 through which the sealed tube 26 passes is formed in the gap adjustment plate 66. A gap g2 is provided between an inner surface 68 of the through-hole 67 and the outer peripheral surface 44 of the sealed tube 26 over the entire periphery of the sealed tube 26. The gap g2 is smaller than the gap g1 at each position on the outer peripheral surface 44 of the sealed tube 26.

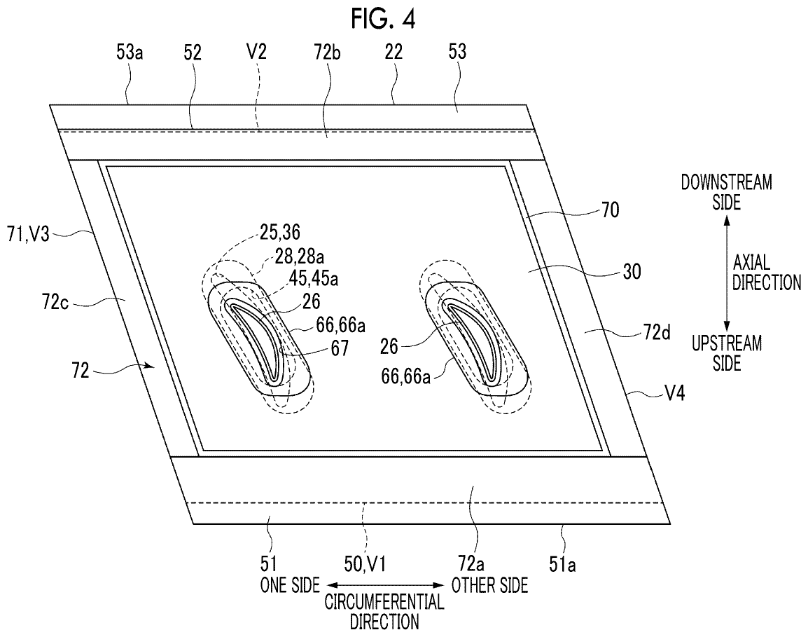

FIG. 4 is a diagram in which the turbine stator vane 12 is seen from the outer side in the vane height direction along the vane height direction. In the example illustrated in FIG. 4, one pair of turbine stator vanes 12 adjacent to each other in the circumferential direction share one outer side shroud 22. That is, the vane-shaped portions 20 of one pair of turbine stator vanes 12 adjacent to each other in the circumferential direction are connected to one outer side shroud 22.

As illustrated in at least one of FIGS. 3 and 4, the outer side shroud 22 includes a bottom plate portion 70 connected to the outer side end 20a of the vane-shaped portion 20 in the vane height direction, and a peripheral wall portion 72 of a frame shape formed along a peripheral edge 71 of the bottom plate portion 70 to protrude outward in the vane height direction from the peripheral edge 71. The bottom plate portion 70 is disposed to face the flow channel 31 (refer to FIG. 2) of the combustion gas in the turbine 8 and forms the outer peripheral wall 33 of the flow channel 31 of the combustion gas in the turbine 8 (the flow channel of the main flow of the combustion gas in the turbine 8). The peripheral wall portion 72 includes an upstream side peripheral wall portion 72a extending in the circumferential direction along an end edge V1 on an upstream side of the peripheral edge 71 of the bottom plate portion 70 in the axial direction, a downstream side peripheral wall portion 72b extending in the circumferential direction along an end edge V2 on a downstream side of the peripheral edge 71 of the bottom plate portion 70 in the axial direction, a one side peripheral wall portion 72c extending in a direction intersecting with the circumferential direction along an end edge V3 on one side (a pressure surface side) of the peripheral edge 71 of the bottom plate portion 70 in the circumferential direction, and an other side peripheral wall portion 72d extending in a direction intersecting with the circumferential direction along an end edge V4 on the other side (a suction surface side) of the peripheral edge 71 of the bottom plate portion 70 in the circumferential direction. The hook 51 is provided to protrude to the upstream side in the axial direction from the end surface 50 of the upstream side peripheral wall portion 72a on the upstream side in the axial direction. The hook 53 is provided to protrude to the downstream side in the axial direction from the end surface 52 of the downstream side peripheral wall portion 72b on the downstream side in the axial direction.

In the exemplary embodiment illustrated in FIG. 4, a cross-sectional shape of each of the passage 25, the sealed tube 26, and the through-hole 67 orthogonal to the vane height direction has a vane shape, and a cross-sectional shape of each of the fixed plate 28 and the through-hole 45 orthogonal to the vane height direction has a rounded oblong shape (an oval shape). In view in the vane height direction, a peripheral edge 28a of the fixed plate 28 is positioned on an outer side of the passage 25, and an inner surface 45a of the through-hole 45 of the fixed plate 28 is positioned on an inner side of a peripheral edge 66a of the gap adjustment plate 66 and on an outer side of the through-hole 67 of the gap adjustment plate 66.

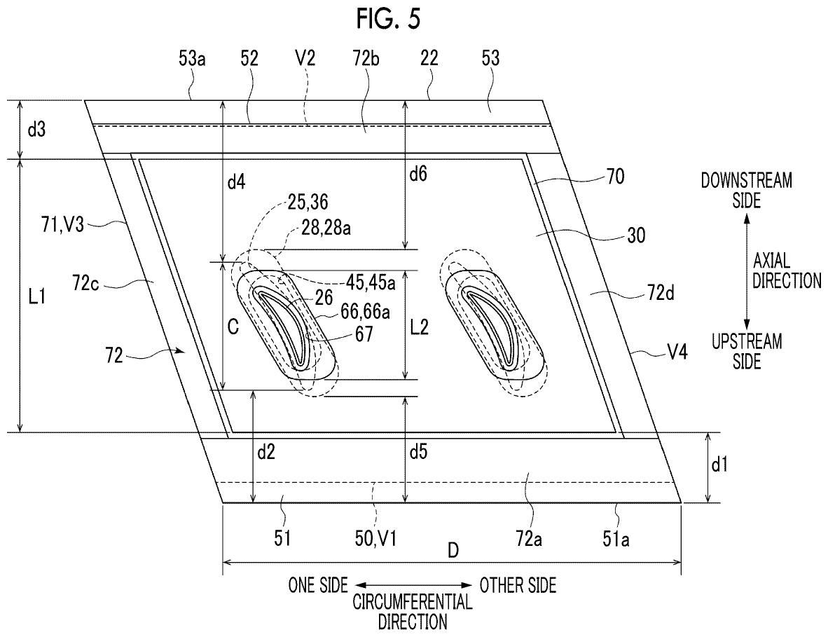

FIG. 5 is a diagram for describing a relationship between dimensions of each portion in FIG. 4.

In the exemplary embodiment illustrated in FIG. 5, a dimension L1 of the heat shield plate 30 in the axial direction is larger than a dimension C of the inlet 36 of the passage 25 in the axial direction. The dimension L1 of the heat shield plate 30 in the axial direction is larger than a dimension L2 of the fixed plate 28 in the axial direction. A distance d1 between the heat shield plate 30 and an upstream end 51a of the outer side shroud 22 in the axial direction is smaller than a distance d2 between the inlet 36 of the passage 25 and the upstream end 51a of the outer side shroud 22 in the axial direction. A distance d3 between the heat shield plate 30 and a downstream end 53a of the outer side shroud 22 in the axial direction is smaller than a distance d4 between the inlet 36 and the downstream end 53a of the outer side shroud 22 in the axial direction. The distance d1 between the heat shield plate 30 and the upstream end 51a of the outer side shroud 22 in the axial direction is smaller than a distance d5 between the fixed plate 28 and the upstream end 51a of the outer side shroud 22 in the axial direction. The distance d3 between the heat shield plate 30 and the downstream end 53a of the outer side shroud 22 in the axial direction is smaller than a distance d6 between the fixed plate 28 and the downstream end 53a of the outer side shroud 22 in the axial direction.

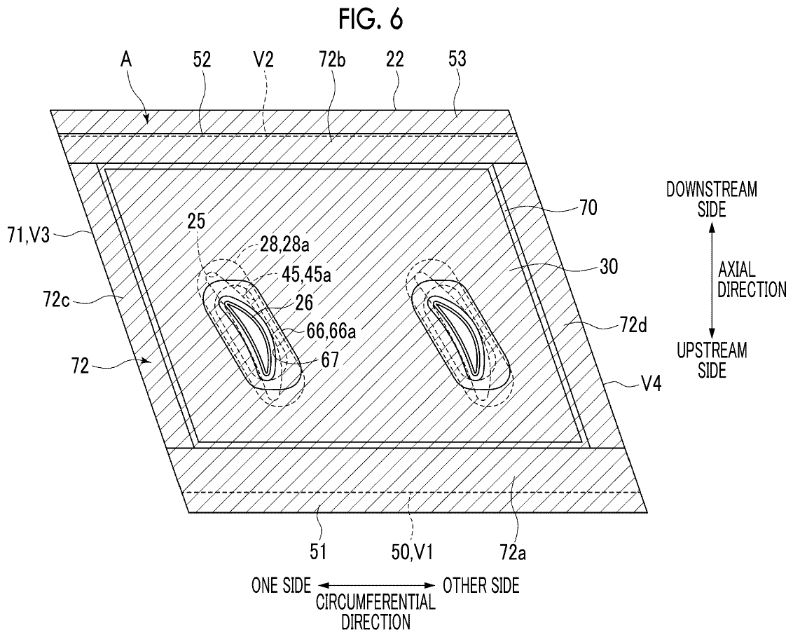

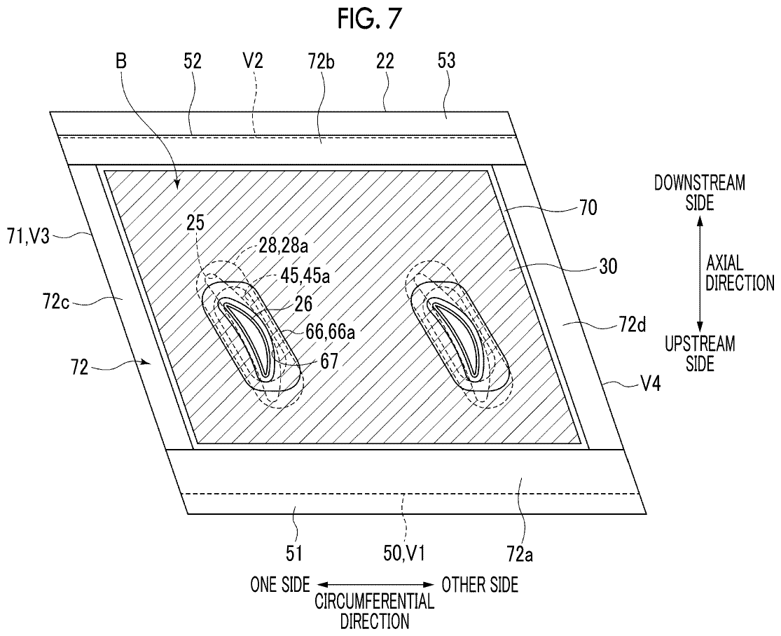

In a case where, for the turbine stator vane 12 described using FIGS. 2 to 5, a projection area (a projection area corresponding to the hatched portion in FIG. 6) in which the outer side shroud 22 is projected to a plane orthogonal to the vane height direction is denoted by A, and a projection area (a projection area corresponding to the hatched portion in FIG. 7) in which the heat shield plate 30 is projected to a plane orthogonal to the vane height direction is denoted by B, B/A≥0.40 is satisfied. A value of B divided by A may be greater than or equal to 0.40, preferably greater than or equal to 0.45, and more preferably greater than or equal to 0.50.

Hereinafter, an effect of the turbine stator vane 12 will be described.

According to the turbine stator vane 12, the cooling air in the outer side cavity 32 is guided to the inner side cavity 34 through an inner side of the sealed tube 26 disposed in the passage 25 passing through the inside of the vane-shaped portion 20. Thus, an increase in the temperature of the cooling air passing through the inner side of the sealed tube 26 because of convection and radiation from a wall surface of the passage 25 inside the vane-shaped portion 20 is suppressed by the sealed tube 26. This can suppress a decrease in cooling capacity of the cooling air.

The heat shield plate 30 disposed on the outer side of the fixed plate 28 in the vane height direction covers at least a part of the outer side shroud 22. In a case where the projection area in which the outer side shroud 22 is projected to the plane orthogonal to the vane height direction is denoted by A, and the projection area in which the heat shield plate 30 is projected to the plane orthogonal to the vane height direction is denoted by B, B/A≥0.40 is satisfied. Thus, an increase of the cooling air in the outer side cavity 32 because of heat input from the outer side shroud 22 is effectively suppressed by the heat shield plate 30. This can suppress an increase in the temperature of the cooling air to be supplied to the turbine stator vane 12. Accordingly, compared to a configuration in which the heat shield plate 30 is not provided, a required cooling effect can be obtained with a small amount of the cooling air, or a high cooling effect can be obtained with the same amount of the cooling air.

According to the turbine stator vane 12, a space surrounded by the heat shield plate 30 and the outer side shroud 22 communicates with the outer side cavity 32 through the gap g1 provided between the heat shield plate 30 and the sealed tube 26. Thus, a difference in pressure between both surfaces of the heat shield plate 30 is suppressed. This can suppress detachment of the heat shield plate 30.

In several embodiments, for example, as illustrated in FIG. 5, in a case where the dimension of the inlet 36 of the passage 25 in the axial direction is denoted by C, the number of turbine stator vanes 12 connected to one outer side shroud 22 is denoted by N, and a dimension of the outer side shroud 22 in the circumferential direction is denoted by D, B≥C×D/N may be satisfied. That is, B may be greater than or equal to a value of C times D divided by N. In the illustrated example, N is 2. Accordingly, an increase of the cooling air in the outer side cavity 32 because of the heat input from the outer side shroud 22 is effectively suppressed by the heat shield plate 30. This can suppress an increase in the temperature of the cooling air to be supplied to the turbine stator vane 12.

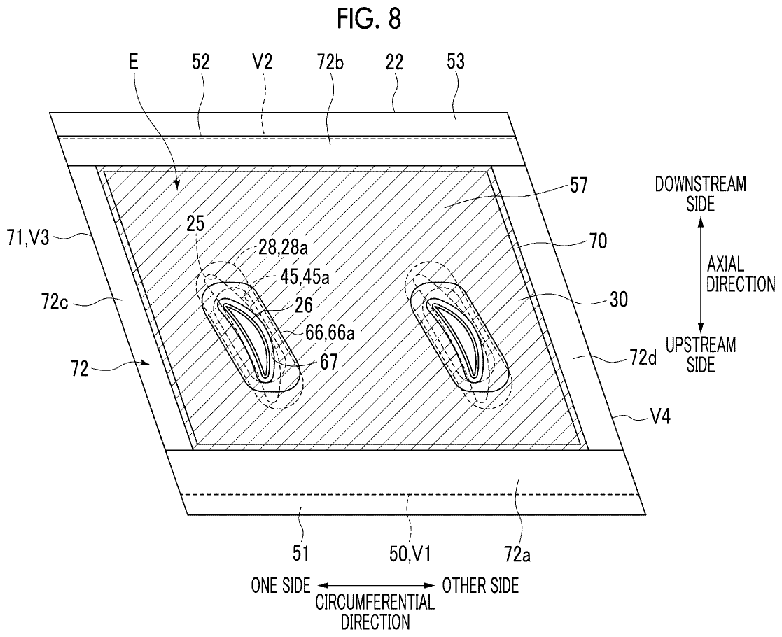

In several embodiments, in a case where the projection area (the projection area corresponding to the hatched portion in FIG. 7) in which the heat shield plate 30 is projected to the plane orthogonal to the vane height direction is denoted by B, and a projection area (a projection area corresponding to the hatched portion in FIG. 8) in which a part 57 (refer to FIG. 8) of the bottom plate portion 70 surrounded by the peripheral wall portion 72 of the frame shape is projected to a plane orthogonal to the vane height direction is denoted by E, B/E≥0.50 is satisfied. A value of B divided by E may be greater than or equal to 0.50, preferably greater than or equal to 0.55, and more preferably greater than or equal to 0.60.

The part 57 of the bottom plate portion 70 surrounded by the peripheral wall portion 72 has a thin wall and is a part most susceptible to heat transfer. Thus, the part 57 significantly affects an amount of the heat input into the cooling air in the outer side cavity 32 from the outer side shroud 22. Thus, it is effective to install the heat shield plate 30 in the part. By satisfying B/E≥0.50 as described above, an increase of the cooling air in the outer side cavity 32 because of the heat input from the outer side shroud 22 is effectively suppressed by the heat shield plate 30. This can suppress an increase in the temperature of the cooling air to be supplied to the turbine stator vane 12.

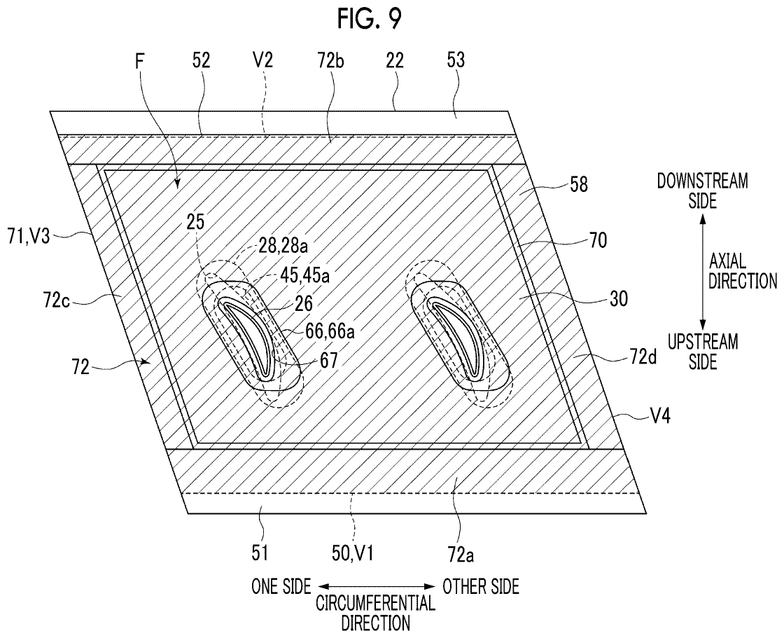

In some embodiments, in a case where the projection area (the projection area corresponding to the hatched portion in FIG. 7) in which the heat shield plate 30 is projected to the plane orthogonal to the vane height direction is denoted by B, and a projection area (an area corresponding to the hatched portion in FIG. 9) in which a part 58 (refer to FIG. 9; in the illustrated example, a part consisting of the peripheral wall portion 72 of the frame shape and the bottom plate portion 70) of the outer side shroud 22 excluding the hooks 51 and 53 is projected to a plane orthogonal to the vane height direction is denoted by F, B/F≥0.45 is satisfied. A value of B divided by F may be greater than or equal to 0.45, preferably greater than or equal to 0.50, and more preferably greater than or equal to 0.55.

The hooks 51 and 53 of the outer side shroud 22 for fixing the outer side shroud 22 to the turbine casing 10 insignificantly affect the amount of the heat input into the cooling air in the outer side cavity 32 from the outer side shroud 22. Thus, by satisfying B/F≥0.45 as described above, an increase of the cooling air in the outer side cavity 32 because of the heat input from the outer side shroud 22 is effectively suppressed by the heat shield plate 30. This can suppress an increase in the temperature of the cooling air to be supplied to the turbine stator vane 12.

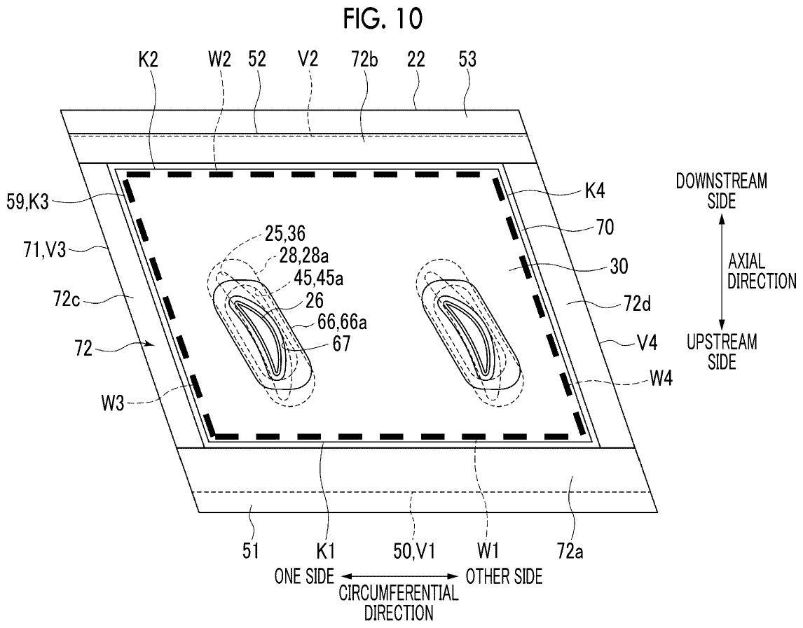

In several embodiments, for example, as illustrated in FIG. 10, in a case where an end edge of a peripheral edge 59 of the heat shield plate 30 on the upstream side in the axial direction is denoted by K1, an end edge of the peripheral edge 59 of the heat shield plate 30 on the downstream side in the axial direction is denoted by K2, an end edge of the peripheral edge 59 of the heat shield plate 30 on one side in the circumferential direction is denoted by K3, and an end edge of the peripheral edge 59 of the heat shield plate 30 on the other side in the circumferential direction is denoted by K4, the turbine stator vane 12 may include a welded portion W1 in which the heat shield plate 30 and the surface 38 of the outer side shroud 22 are welded to each other along the end edge K1, a welded portion W2 in which the heat shield plate 30 and the surface 38 of the outer side shroud 22 are welded to each other along the end edge K2, a welded portion W3 in which the heat shield plate 30 and the surface 38 of the outer side shroud 22 are welded to each other along the end edge K3, and a welded portion W4 in which the heat shield plate 30 and the surface 38 of the outer side shroud 22 are welded to each other along the end edge K4. In the illustrated example, in the welded portion W1, the heat shield plate 30 and the surface 38 of the outer side shroud 22 are welded to each other at a plurality of locations at intervals along the end edge K1. In the welded portion W2, the heat shield plate 30 and the surface 38 of the outer side shroud 22 are welded to each other at a plurality of locations at intervals along the end edge K2. In the welded portion W3, the heat shield plate 30 and the surface 38 of the outer side shroud 22 are welded to each other at a plurality of locations at intervals along the end edge K3. In the welded portion W4, the heat shield plate 30 and the surface 38 of the outer side shroud 22 are welded to each other at a plurality of locations at intervals along the end edge K4.

Accordingly, by providing the welded portions W1, W2, W3, and W4, not only detachment of the heat shield plate 30 is suppressed, but also entry or exit of the cooling air in the outer side cavity 32 into or from a gap between the heat shield plate 30 and the outer side shroud 22 through a space between the peripheral edge 59 of the heat shield plate 30 and the outer side shroud 22 is suppressed. This can suppress an increase in the temperature of the cooling air caused by the entry or exit.

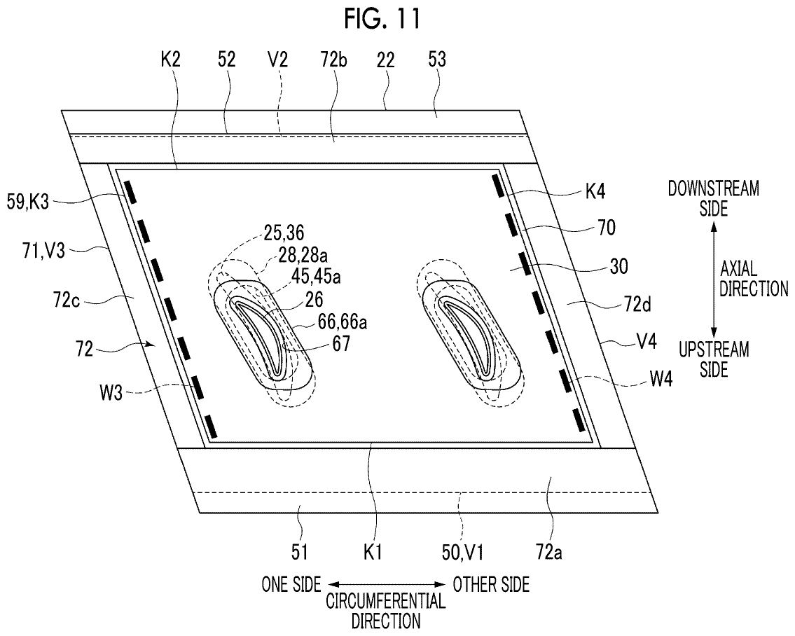

In several embodiments, for example, as illustrated in FIG. 11, in a case where the end edge of the peripheral edge 59 of the heat shield plate 30 on the upstream side in the axial direction is denoted by K1, the end edge of the peripheral edge 59 of the heat shield plate 30 on the downstream side in the axial direction is denoted by K2, the end edge of the peripheral edge 59 of the heat shield plate 30 on one side in the circumferential direction is denoted by K3, and the end edge of the peripheral edge 59 of the heat shield plate 30 on the other side in the circumferential direction is denoted by K4, the turbine stator vane 12 may not be provided with the welded portion in which the heat shield plate 30 and the surface 38 of the outer side shroud 22 are welded to each other along the end edge K1, and the welded portion in which the heat shield plate 30 and the surface 38 of the outer side shroud 22 are welded to each other along the end edge K2. In the example illustrated in FIG. 10, the turbine stator vane 12 is provided with the welded portion W3 in which the heat shield plate 30 and the surface 38 of the outer side shroud 22 are welded to each other along the end edge K3, and the welded portion W4 in which the heat shield plate 30 and the surface 38 of the outer side shroud 22 are welded to each other along the end edge K4. In the illustrated example, the heat shield plate 30 and the surface 38 of the outer side shroud 22 are welded to each other at a plurality of locations at intervals along the end edge K3 in the welded portion W3, and the heat shield plate 30 and the surface 38 of the outer side shroud 22 are welded to each other at a plurality of locations at intervals along the end edge K4 in the welded portion W4.

The cooling air in the outer side cavity 32 flows along the circumferential direction. Thus, by providing the welded portion W3 in which the heat shield plate 30 and the outer side shroud 22 are welded to each other along the end edge K3 of the peripheral edge 59 of the heat shield plate 30 on one side in the circumferential direction, and the welded portion W4 in which the heat shield plate 30 and the outer side shroud 22 are welded to each other along the end edge K4 of the peripheral edge 59 of the heat shield plate 30 on the other side in the circumferential direction, entry or exit of the cooling air in the outer side cavity 32 into or from the gap between the heat shield plate 30 and the outer side shroud through the space between the peripheral edge 59 of the heat shield plate 30 and the outer side shroud 22 is suppressed. This can suppress an increase in the temperature of the cooling air because of the entry or exit. The welded portion in which the heat shield plate 30 and the outer side shroud 22 are welded to each other along the end edge K1 of the peripheral edge 59 of the heat shield plate 30 on the upstream side in the axial direction, and the welded portion in which the heat shield plate 30 and the outer side shroud 22 are welded to each other along the end edge K2 of the peripheral edge 59 of the heat shield plate 30 on the downstream side in the axial direction are not provided. Thus, an increase in the temperature of the cooling air caused by the entry or exit can be suppressed while reducing labor and costs of welding.

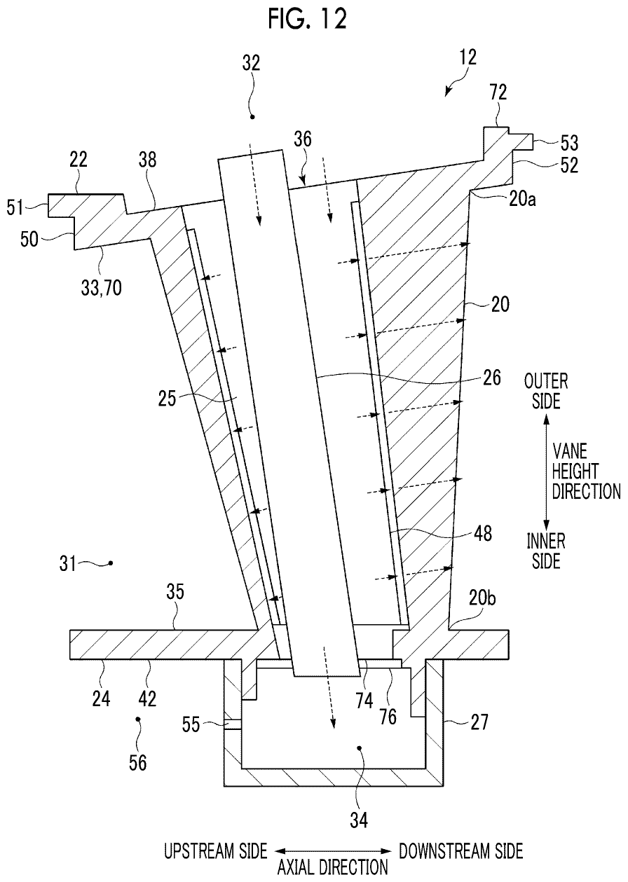

FIG. 12 is a diagram illustrating a modification example of the turbine stator vane 12 illustrated in FIG. 2 and is a diagram illustrating another example of the cross section taken along the vane height direction in the turbine stator vane 12. In the turbine stator vane 12 described below, unless otherwise specified, the same reference sign as each configuration of the turbine stator vane 12 illustrated in FIG. 2 indicates the same configuration as each configuration of the turbine stator vane 12 illustrated in FIG. 2 and will not be described.

In the exemplary embodiment in FIG. 12, the turbine stator vane 12 includes a fixed plate 74 fixed to the inner side shroud 24, and a heat shield plate 76. The turbine stator vane 12 also includes an insert 48 of a cylindrical shape inserted into the passage 25. The insert 48 includes an impingement cooling hole (not illustrated) passing through an inner peripheral surface and an outer peripheral surface of the insert 48. A gap is provided between the outer peripheral surface of the insert 48 and an inner surface (a wall surface of the passage 25) of the vane-shaped portion 20.

In the exemplary embodiment illustrated in FIG. 12, the sealed tube 26 is disposed on an inner side of the insert 48 in the passage 25 along the direction in which the passage 25 extends (the axis line direction of the passage 25). The sealed tube 26 is configured to guide the air in the outer side cavity 32 to the inner side cavity 34 on the inner side of the inner side shroud 24 in the vane height direction.

The compressed air from the compressor 4 is supplied to the outer side cavity 32 as the cooling air. The cooling air that has entered the sealed tube 26 from the outer side cavity 32 is supplied to the inter-stage space 56 (the disc cavity) between the turbine stator vane 12 and the turbine rotor vane 16 (refer to FIG. 1) adjacent to the upstream side of the turbine stator vane 12 through the holes 55 formed in the inner side cavity 34 and the inner peripheral side diaphragm 27, and functions as the cooling air. The cooling air that has entered the insert 48 from the outer side cavity 32 is jetted to the inner surface of the vane-shaped portion 20 from the impingement cooling hole (not illustrated) formed in the insert 48 and then flows out to an outer surface side of the vane-shaped portion 20 from a film cooling hole (not illustrated) formed in the vane-shaped portion 20.

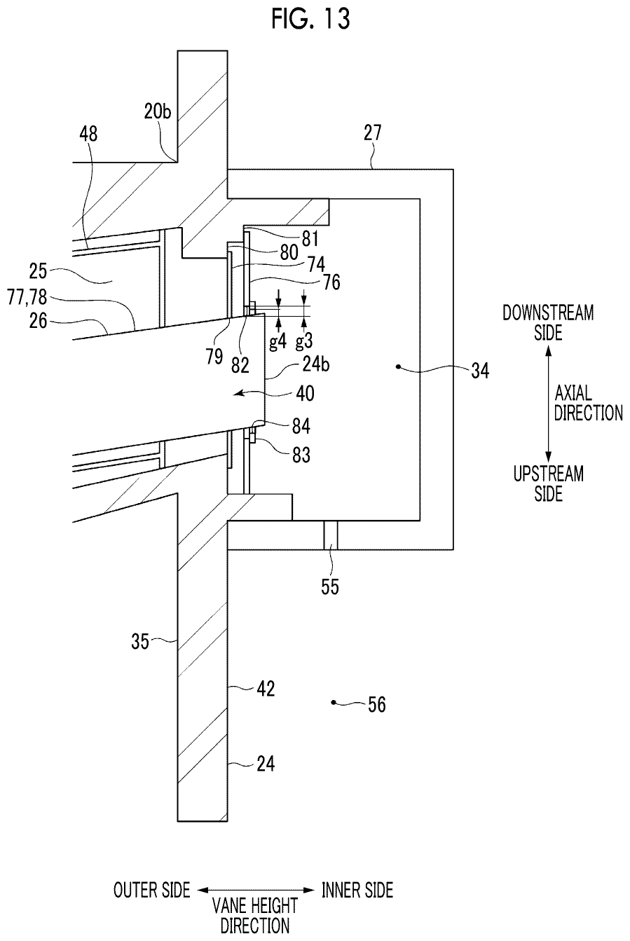

FIG. 13 is an enlarged view of an end portion of the turbine stator vane 12 illustrated in FIG. 12 on the inner side in the vane height direction.

As illustrated in FIG. 13, the fixed plate 74 is attached to the outer peripheral surface 78 of an end portion 77 of the sealed tube 26 on the inner side in the vane height direction and fixed to the outer peripheral surface 78. The sealed tube 26 is provided to pass through a through-hole 79 formed in a center portion of the fixed plate 74, and the outer peripheral surface 78 of the sealed tube 26 and an inner surface of the through-hole 79 are joined to each other by, for example, welding. The fixed plate 74 is disposed on a wall surface 80 of the inner side shroud 24 on the inner side in the vane height direction to close a part of the outlet 40 of the passage 25 on the outer side of the sealed tube 26, and is fixed to the wall surface 80.

The heat shield plate 76 is disposed on an inner side of the fixed plate 74 in the vane height direction (an inner side of the fixed plate 74 in the radial direction). The heat shield plate 76 is disposed to cover at least a part of the fixed plate 74 at a gap from the fixed plate 74 in the vane height direction. In the illustrated example, the heat shield plate 76 is disposed parallel to each of the wall surface 80 and the fixed plate 74 at a gap from each of the fixed plate 74 and the wall surface 80 in the vane height direction. A through-hole 82 through which the sealed tube 26 passes is formed in the heat shield plate 76, and a gap g3 is provided between an inner surface of the through-hole 82 and the outer peripheral surface 78 of the sealed tube 26 over the entire periphery of the sealed tube 26. In the illustrated exemplary embodiment, a step is formed in the vane height direction between the wall surface 80 of the inner side shroud 24 to which the fixed plate 74 is fixed, and a wall surface 81 of the inner side shroud 24 to which the heat shield plate 76 is fixed. The wall surface 81 is positioned on an inner side of the wall surface 81 in the vane height direction.

An impingement cooling hole for impingement cooling of the wall surface 80 of the inner side shroud 24 is not formed in the heat shield plate 76. In the illustrated configuration, an inner side end 26b of the sealed tube 26 in the vane height direction is positioned on an inner side of the heat shield plate 76 in the vane height direction. However, the inner side end 26b of the sealed tube 26 may be positioned at the same position as the heat shield plate 76 or on an outer side of the heat shield plate 76 in the vane height direction.

In the illustrated exemplary embodiment, a gap adjustment plate 83 is disposed on the heat shield plate 76, and a through-hole 84 through which the sealed tube 26 passes is formed in the gap adjustment plate 83. A gap g4 is provided between an inner surface of the through-hole 84 and an outer peripheral surface 28 of the sealed tube 26 over the entire periphery of the sealed tube 26. At each position on the outer peripheral surface 44 of the sealed tube 26, the gap g4 between the gap adjustment plate 83 and the outer peripheral surface 44 of the sealed tube 26 is smaller than the gap g3 between the heat shield plate 76 and the outer peripheral surface 44 of the sealed tube 26.

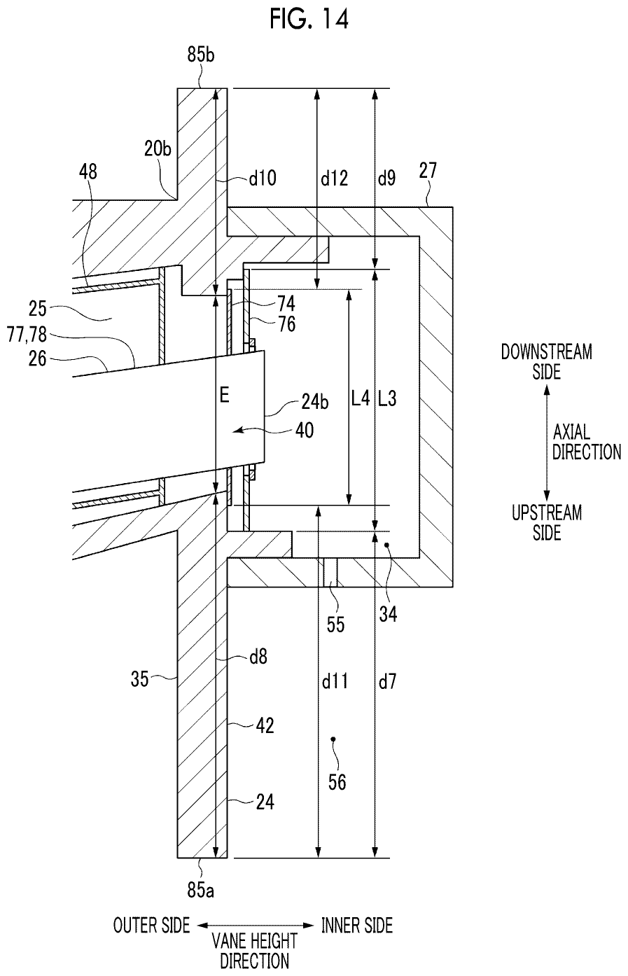

FIG. 14 is a diagram for describing a configuration of the end portion of the turbine stator vane 12 illustrated in FIG. 13 on the inner side in the vane height direction.

As illustrated in FIG. 14, a dimension L3 of the heat shield plate 76 in the axial direction is larger than a dimension E of the outlet 40 of the passage 25 in the axial direction. The dimension L3 of the heat shield plate 76 in the axial direction is larger than a dimension L4 of the fixed plate 28 in the axial direction. A distance d7 between the heat shield plate 76 and an upstream end 85a of the inner side shroud 24 in the axial direction is smaller than a distance d8 between the outlet 40 of the passage 25 and the upstream end 85a of the inner side shroud 24 in the axial direction. A distance d9 between the heat shield plate 76 and a downstream end 85b of the inner side shroud 24 in the axial direction is smaller than a distance d10 between the outlet 40 and the downstream end 85b of the inner side shroud 24 in the axial direction. The distance d7 between the heat shield plate 76 and the upstream end 85a of the inner side shroud 24 in the axial direction is smaller than a distance d11 between the fixed plate 74 and the upstream end 85a of the inner side shroud 24 in the axial direction. The distance d9 between the heat shield plate 76 and the downstream end 85b of the inner side shroud 24 in the axial direction is smaller than a distance d12 between the fixed plate 74 and the downstream end 85b of the inner side shroud 24 in the axial direction.

Hereinafter, an effect of the turbine stator vane 12 described using FIGS. 12 to 14 will be described.

According to the turbine stator vane 12, the cooling air in the outer side cavity 32 is guided to the inner side cavity 34 through the inner side of the sealed tube 26 disposed in the passage 25 passing through the inside of the vane-shaped portion 20. Thus, an increase in the temperature of the cooling air passing through the inner side of the sealed tube 26 because of convection and radiation from the wall surface of the passage 25 and an inner surface of the insert 48 inside the vane-shaped portion 20 is suppressed by the sealed tube 26. This can suppress a decrease in the cooling capacity of the cooling air. In addition, leakage of air after being used for cooling the vane-shaped portion 20 into the inner peripheral side cavity 34 through a gap between an outer surface of the insert 48 and the inner surface of the vane-shaped portion 20 can be suppressed by the fixed plate 74.

The heat shield plate 76 disposed on the inner side of the fixed plate 74 in the vane height direction (the inner side of the fixed plate 74 in the radial direction) covers at least a part of the inner side shroud 24. Thus, an increase of the cooling air in the inner side cavity 34 because of heat input from the inner side shroud 24 is effectively suppressed by the heat shield plate 76. This can suppress an increase in the temperature of the cooling air to be supplied to the inter-stage space 56 (the disc cavity). Accordingly, compared to a configuration in which the heat shield plate 76 is not provided, a required cooling effect can be obtained with a small amount of the cooling air, or a high cooling effect can be obtained with the same amount of the cooling air.

According to the turbine stator vane 12, a space surrounded by the heat shield plate 76, the inner side shroud 24, and the fixed plate 74 communicates with the inner side cavity 34 through the gap g3 provided between the heat shield plate 76 and the sealed tube 26. Thus, a difference in pressure between both surfaces of the heat shield plate 76 is suppressed. This can suppress detachment of the heat shield plate 76.

The present disclosure is not limited to the embodiments and includes aspects obtained by modifying the embodiments and aspects obtained by appropriately combining the aspects.

For example, contents disclosed in each of the embodiments are understood as follows.

(1) A gas turbine stator vane (for example, the turbine stator vane 12) according to at least one embodiment of the present disclosure is provided with a vane-shaped portion (for example, the vane-shaped portion 20), an outer side shroud (for example, the outer side shroud 22) connected to an outer side end (for example, the outer side end 20a) of the vane-shaped portion in a vane height direction, an inner side shroud (for example, the inner side shroud 24) connected to an inner side end (for example, the inner side end 20b) of the vane-shaped portion in the vane height direction, a passage (for example, the passage 25) passing through an inside of the vane-shaped portion to provide communication between an outer side cavity (for example, the outer side cavity 32) formed on an outer side of the outer side shroud in the vane height direction and an inner side cavity (for example, the inner side cavity 34) formed on an inner side of the inner side shroud in the vane height direction, a sealed tube (for example, the sealed tube 26) that is disposed in the passage and that is configured to guide air in the outer side cavity to the inner side cavity, a fixed plate (for example, the fixed plate 28) attached to the sealed tube and fixed to the outer side shroud, and a heat shield plate (for example, the heat shield plate 30) that is disposed on an outer side of the fixed plate in the vane height direction and that is disposed to cover at least a part of the outer side shroud, in which, in a case where a projection area in which the outer side shroud is projected to a plane orthogonal to the vane height direction is denoted by A, and a projection area in which the heat shield plate is projected to a plane orthogonal to the vane height direction is denoted by B, B/A≥0.40 is satisfied.

According to the gas turbine stator vane according to (1), cooling air in the outer side cavity is guided to the inner side cavity through an inner side of the sealed tube disposed in the passage passing through the inside of the vane-shaped portion. Thus, an increase in a temperature of the cooling air passing through the inner side of the sealed tube because of convection and radiation from a wall surface of the passage inside the vane-shaped portion is suppressed. This can suppress a decrease in cooling capacity of the cooling air. The heat shield plate disposed on the outer side of the fixed plate in the vane height direction covers at least a part of the outer side shroud. In a case where the projection area in which the outer side shroud is projected to the plane orthogonal to the vane height direction is denoted by A, and the projection area in which the heat shield plate is projected to the plane orthogonal to the vane height direction is denoted by B, B/A≥0.40 is satisfied. Thus, an increase of the cooling air in the outer side cavity because of heat input from the outer side shroud is effectively suppressed by the heat shield plate. This can suppress an increase in the temperature of the cooling air to be supplied to the gas turbine stator vane.

(2) In several embodiments, in the gas turbine stator vane according to (1), in a case where a dimension of an inlet of the passage in an axial direction of a gas turbine is denoted by C, the number of gas turbine stator vanes connected to the outer side shroud is denoted by N, and a dimension of the outer side shroud in a circumferential direction of the gas turbine is denoted by D, B≥C×D/N is satisfied.

According to the gas turbine stator vane according to (2), an increase of the cooling air in the outer side cavity because of the heat input from the outer side shroud is effectively suppressed by the heat shield plate. This can suppress an increase in the temperature of the cooling air to be supplied to the gas turbine stator vane.

(3) In several embodiments, in the gas turbine stator vane according to (1) or (2), the outer side shroud includes a bottom plate portion (for example, the bottom plate portion 70) connected to the outer side end of the vane-shaped portion in the vane height direction, and a peripheral wall portion (for example, the peripheral wall portion 72) formed along a peripheral edge (for example, the peripheral edge 71) of the bottom plate portion to protrude outward in the vane height direction from the peripheral edge, the heat shield plate is provided to cover at least a part of a part (for example, the part 57) of the bottom plate portion surrounded by the peripheral wall portion, and in a case where a projection area in which the part of the bottom plate portion surrounded by the peripheral wall portion is projected to a plane orthogonal to the vane height direction is denoted by E, B/E≥0.50 is satisfied.

The part of the bottom plate portion surrounded by the peripheral wall portion has a thin wall and is a part most susceptible to heat transfer. Thus, the part significantly affects the amount of the heat input into the cooling air in the outer side cavity from the outer side shroud. Thus, it is effective to install the heat shield plate in the part of the bottom plate portion surrounded by the peripheral wall portion. By satisfying B/E≥0.50 as described in (3), an increase of the cooling air in the outer side cavity because of the heat input from the outer side shroud is effectively suppressed by the heat shield plate. This can suppress an increase in the temperature of the cooling air to be supplied to the gas turbine stator vane.

(4) In several embodiments, in the gas turbine stator vane according to any one of (1) to (3), in a case where a projection area in which a part (for example, the part 58) of the outer side shroud excluding a hook (for example, the hooks 51 and 53) for fixing the outer side shroud to a turbine casing is projected to a plane orthogonal to the vane height direction is denoted by F, B/F≥0.45 is satisfied.

The hook of the outer side shroud for fixing the outer side shroud to the turbine casing insignificantly affects an amount of the heat input into the cooling air in the outer side cavity from the outer side shroud. Thus, by satisfying B/F≥0.45 as described in (4), an increase of the cooling air in the outer side cavity because of the heat input from the outer side shroud is effectively suppressed by the heat shield plate. This can suppress an increase in the temperature of the cooling air to be supplied to the gas turbine stator vane.

(5) In several embodiments, in the gas turbine stator vane according to any one of (1) to (4), a dimension (for example, the dimension L1) of the heat shield plate in an axial direction of a gas turbine is larger than a dimension (for example, the dimension C) of an inlet of the passage in the axial direction.

According to the gas turbine stator vane according to (5), an increase of the cooling air in the outer side cavity because of the heat input from the outer side shroud is effectively suppressed by the heat shield plate. This can suppress an increase in the temperature of the cooling air to be supplied to the gas turbine stator vane.

(6) In several embodiments, in the gas turbine stator vane according to any one of (1) to (5), a dimension (for example, the dimension L1) of the heat shield plate in an axial direction of a gas turbine is larger than a dimension (for example, the dimension L2) of the fixed plate in the axial direction.

According to the gas turbine stator vane according to (6), an increase of the cooling air in the outer side cavity because of the heat input from the outer side shroud is effectively suppressed by the heat shield plate. This can suppress an increase in the temperature of the cooling air to be supplied to the gas turbine stator vane.

(7) In several embodiments, in the gas turbine stator vane according to any one of (1) to (6), in the heat shield plate, a distance (for example, the distance d1) between the heat shield plate and an upstream end of the outer side shroud in an axial direction of a gas turbine is smaller than a distance (for example, the distance d2) between an inlet of the passage and the upstream end of the outer side shroud in the axial direction, and a distance (for example, the distance d3) between the heat shield plate and a downstream end of the outer side shroud in the axial direction is smaller than a distance (for example, the distance d4) between the inlet and the downstream end of the outer side shroud in the axial direction.

According to the gas turbine stator vane according to (7), an increase of the cooling air in the outer side cavity because of the heat input from the outer side shroud is effectively suppressed by the heat shield plate. This can suppress an increase in the temperature of the cooling air to be supplied to the gas turbine stator vane.

(8) In several embodiments, in the gas turbine stator vane according to any one of (1) to (7), in the heat shield plate, a distance (for example, the distance d1) between the heat shield plate and an upstream end of the outer side shroud in an axial direction of a gas turbine is smaller than a distance (for example, the distance d5) between the fixed plate and the upstream end of the outer side shroud in the axial direction, and a distance (for example, the distance d3) between the heat shield plate and a downstream end of the outer side shroud in the axial direction is smaller than a distance (for example, the distance d6) between the fixed plate and the downstream end of the outer side shroud in the axial direction.

According to the gas turbine stator vane according to (8), an increase of the cooling air in the outer side cavity because of the heat input from the outer side shroud is effectively suppressed by the heat shield plate. This can suppress an increase in the temperature of the cooling air to be supplied to the gas turbine stator vane.

(9) In several embodiments, in the gas turbine stator vane according to any one of (1) to (8), a gap (for example, the gap g1) is provided between the heat shield plate and the sealed tube.

According to the gas turbine stator vane according to (9), a space surrounded by the heat shield plate and the outer side shroud communicates with the outer side cavity through the gap provided between the heat shield plate and the sealed tube. Thus, a difference in pressure between both surfaces of the heat shield plate is suppressed. This can suppress detachment of the heat shield plate.

(10) In several embodiments, in the gas turbine stator vane according to any one of (1) to (9), an impingement cooling hole for impingement cooling of the outer side shroud is not formed in the heat shield plate.

According to the gas turbine stator vane according to (10), an increase of the cooling air in the outer side cavity because of the heat input from the outer side shroud is effectively suppressed by the heat shield plate. This can suppress an increase in the temperature of the cooling air to be supplied to the gas turbine stator vane.

(11) In several embodiments, the gas turbine stator vane according to any one of (1) to (10) is further provided with a welded portion (for example, the welded portion W1) in which the heat shield plate and the outer side shroud are welded to each other along an end edge (for example, the end edge K1) of a peripheral edge (for example, the peripheral edge 59) of the heat shield plate on an upstream side in an axial direction of a gas turbine, a welded portion (for example, the welded portion W2) in which the heat shield plate and the outer side shroud are welded to each other along an end edge (for example, the end edge K2) of the peripheral edge of the heat shield plate on a downstream side in the axial direction, a welded portion (for example, the welded portion W3) in which the heat shield plate and the outer side shroud are welded to each other along an end edge (for example, the end edge K3) of the peripheral edge of the heat shield plate on one side in a circumferential direction of the gas turbine, and a welded portion (for example, the welded portion W4) in which the heat shield plate and the outer side shroud are welded to each other along an end edge (for example, the end edge K4) of the peripheral edge of the heat shield plate on the other side in the circumferential direction.

According to the gas turbine stator vane according to (11), by providing each welded portion, not only detachment of the heat shield plate is suppressed, but also entry or exit of the cooling air in the outer side cavity into or from a gap between the heat shield plate and the outer side shroud through a space between the peripheral edge of the heat shield plate and the outer side shroud is suppressed. This can suppress an increase in the temperature of the cooling air caused by the entry or exit.

(12) In several embodiments, the gas turbine stator vane according to any one of (1) to (10) is further provided with a welded portion (for example, the welded portion W3) in which the heat shield plate and the outer side shroud are welded to each other along an end edge (for example, the end edge K3) of a peripheral edge of the heat shield plate on one side in a circumferential direction of a gas turbine, and a welded portion (for example, the welded portion W4) in which the heat shield plate and the outer side shroud are welded to each other along an end edge (for example, the end edge K4) of the peripheral edge of the heat shield plate on the other side in the circumferential direction, in which the gas turbine stator vane is not provided with a welded portion (for example, the welded portion W1) in which the heat shield plate and the outer side shroud are welded to each other along an end edge (for example, the end edge K1) of the peripheral edge (for example, the peripheral edge 59) of the heat shield plate on an upstream side in an axial direction of the gas turbine, and a welded portion (for example, the welded portion W2) in which the heat shield plate and the outer side shroud are welded to each other along an end edge (for example, the end edge K2) of the peripheral edge of the heat shield plate on a downstream side in the axial direction.

The cooling air in the outer side cavity flows along the circumferential direction. Thus, as described in (12), by providing the welded portion in which the heat shield plate and the outer side shroud are welded to each other along the end edge of the peripheral edge of the heat shield plate on one side in the circumferential direction, and the welded portion in which the heat shield plate and the outer side shroud are welded to each other along the end edge of the peripheral edge of the heat shield plate on the other side in the circumferential direction, entry or exit of the cooling air in the outer side cavity into or from the gap between the heat shield plate and the outer side shroud through the space between the peripheral edge of the heat shield plate and the outer side shroud is suppressed. This can suppress an increase in the temperature of the cooling air because of the entry or exit. The welded portion in which the heat shield plate and the outer side shroud are welded to each other along the end edge of the peripheral edge of the heat shield plate on the upstream side in the axial direction of the gas turbine, and the welded portion in which the heat shield plate and the outer side shroud are welded to each other along the end edge of the peripheral edge of the heat shield plate on the downstream side in the axial direction are not provided. Thus, an increase in the temperature of the cooling air caused by the entry or exit can be suppressed while reducing labor and costs of welding.

(13) A gas turbine stator vane (for example, the turbine stator vane 12) according to at least one embodiment of the present disclosure is provided with a vane-shaped portion (for example, the vane-shaped portion 20), an outer side shroud (for example, the outer side shroud 22) connected to an outer side end (for example, the outer side end 20a) of the vane-shaped portion in a vane height direction, an inner side shroud (for example, the inner side shroud 24) connected to an inner side end (for example, the inner side end 20b) of the vane-shaped portion in the vane height direction, a passage (for example, the passage 25) passing through an inside of the vane-shaped portion to provide communication between an outer side cavity (for example, the outer side cavity 32) formed on an outer side of the outer side shroud in the vane height direction and an inner side cavity (for example, the inner side cavity 34) formed on an inner side of the inner side shroud in the vane height direction, a sealed tube (for example, the sealed tube 26) that is disposed in the passage and that is configured to guide air in the outer side cavity to the inner side cavity, a fixed plate (for example, the fixed plate 74) attached to the sealed tube and fixed to the inner side shroud, and a heat shield plate (for example, the heat shield plate 76) that is disposed on an inner side of the fixed plate in the vane height direction and that is disposed to cover at least a part of the inner side shroud.

According to the gas turbine stator vane according to (13), cooling air in the outer side cavity is guided to the inner side cavity through an inner side of the sealed tube disposed in the passage passing through the inside of the vane-shaped portion. Thus, an increase in a temperature of the cooling air passing through the inner side of the sealed tube because of convection and radiation from a wall surface or the like of the passage inside the vane-shaped portion is suppressed. This can suppress a decrease in cooling capacity of the cooling air. The heat shield plate disposed on the inner side of the fixed plate in the vane height direction (the inner side of the fixed plate in a radial direction of a gas turbine) covers at least a part of the inner side shroud. Thus, an increase of the cooling air in the inner side cavity because of heat input from the inner side shroud is effectively suppressed by the heat shield plate. This can suppress an increase in the temperature of the cooling air to be supplied to a disc cavity. Accordingly, compared to a configuration in which the heat shield plate is not provided, a required cooling effect can be obtained with a small amount of the cooling air, or a high cooling effect can be obtained with the same amount of the cooling air.

(14) In several embodiments, in the gas turbine stator vane according to (13), a dimension (for example, the dimension L3) of the heat shield plate in an axial direction of a gas turbine is larger than a dimension (for example, the dimension E) of an outlet of the passage in the axial direction.

According to the gas turbine stator vane according to (14), an increase of the cooling air in the inner side cavity because of the heat input from the inner side shroud is effectively suppressed by the heat shield plate. This can suppress an increase in the temperature of the cooling air to be supplied to the gas turbine stator vane.

(15) In several embodiments, in the gas turbine stator vane according to (13) or (14), a dimension (for example, the dimension L3) of the heat shield plate in an axial direction of a gas turbine is larger than a dimension (for example, the dimension L4) of the fixed plate in the axial direction.

According to the gas turbine stator vane according to (15), an increase of the cooling air in the inner side cavity because of the heat input from the inner side shroud is effectively suppressed by the heat shield plate. This can suppress an increase in the temperature of the cooling air to be supplied to the gas turbine stator vane.

(16) In several embodiments, in the gas turbine stator vane according to any one of (13) to (15), in the heat shield plate, a distance (for example, the distance d7) between the heat shield plate and an upstream end of the inner side shroud in an axial direction of a gas turbine is smaller than a distance (for example, the distance d8) between an outlet of the passage and the upstream end of the inner side shroud in the axial direction, and a distance (for example, the distance d9) between the heat shield plate and a downstream end of the inner side shroud in the axial direction is smaller than a distance (for example, the distance d10) between the outlet and the downstream end of the inner side shroud in the axial direction.

According to the gas turbine stator vane according to (16), an increase of the cooling air in the inner side cavity because of the heat input from the inner side shroud is effectively suppressed by the heat shield plate. This can suppress an increase in the temperature of the cooling air to be supplied to the gas turbine stator vane.

(17) In several embodiments, in the gas turbine stator vane according to any one of (13) to (16), in the heat shield plate, a distance (for example, the distance d7) between the heat shield plate and an upstream end of the inner side shroud in an axial direction of a gas turbine is smaller than a distance (for example, the distance d11) between the fixed plate and the upstream end of the inner side shroud in the axial direction, and a distance (for example, the distance d9) between the heat shield plate and a downstream end of the inner side shroud in the axial direction is smaller than a distance (for example, the distance d12) between the fixed plate and the downstream end of the inner side shroud in the axial direction.

(18) In several embodiments, in the gas turbine stator vane according to any one of (13) to (17), a gap (for example, the gap g3) is provided between the heat shield plate and the sealed tube.

According to the gas turbine stator vane according to (18), a space surrounded by the heat shield plate and the inner side shroud communicates with the inner side cavity through the gap provided between the heat shield plate and the sealed tube. Thus, a difference in pressure between both surfaces of the heat shield plate is suppressed. This can suppress detachment of the heat shield plate.

(19) A gas turbine according to at least one embodiment of the present disclosure is provided with the gas turbine stator vane according to any one of (1) to (18), a turbine rotor, and a turbine casing accommodating the turbine rotor.

According to the gas turbine according to (19), the gas turbine stator vane according to any one of (1) to (18) is provided. Thus, an increase of the cooling air because of the heat input from the outer side shroud or the inner side shroud is effectively suppressed by the heat shield plate. This can suppress an increase in the temperature of the cooling air to be supplied to the gas turbine stator vane.

### REFERENCE SIGNS LIST

2: gas turbine
4: compressor
6: combustor
8: turbine
9: rotor (turbine rotor)
10: turbine casing
12: turbine stator vane
16: turbine rotor vane
20: vane-shaped portion
20a: outer side end
20b: inner side end
22: outer side shroud
24: inner side shroud
25: passage
26: sealed tube
26a: outer side end
26b: inner side end
27: inner peripheral side diaphragm
28, 74: fixed plate
28a, 59, 61, 66a, 71: peripheral edge
30, 6: heat shield plate
31: flow channel
32: outer side cavity
33: outer peripheral wall
34: inner side cavity
35: inner peripheral wall
36: inlet
38, 42, 80, 81: wall surface
40: outlet
43, 77: end portion
44, 78: outer peripheral surface
45, 64, 67, 79, 82, 84: through-hole
45a, 46, 65, 68: inner surface
50, 52: end surface
51, 53: hook
51a, 85a: upstream end
53a, 85b: downstream end
55: hole
56: inter-stage space
57, 58: part
60: top plate portion
62: side wall portion
66, 83: gap adjustment plate
70: bottom plate portion
72: peripheral wall portion
72a, 72b: upstream side peripheral wall portion
72b: downstream side peripheral wall portion
72c: one side peripheral wall portion
72d: other side peripheral wall portion
A, B, E, F: projection area
C, D: dimension
K1, K2, K3, K4, V1, V2, V3, V4: end edge
W1, W2, W3, W4: welded portion
d1, d2, d3, d4, d5, d6, d7, d8, d9, d10, d11, d12: distance
g1, g2, g3, g4: gap

1. A gas turbine stator vane comprising:
a vane-shaped portion;
an outer side shroud connected to an outer side end of the vane-shaped portion in a vane height direction;
an inner side shroud connected to an inner side end of the vane-shaped portion in the vane height direction;
a passage passing through an inside of the vane-shaped portion to provide communication between an outer side cavity formed on an outer side of the outer side shroud in the vane height direction and an inner side cavity formed on an inner side of the inner side shroud in the vane height direction;
a sealed tube that is disposed in the passage and that is configured to guide air in the outer side cavity to the inner side cavity;
a fixed plate attached to the sealed tube and fixed to the outer side shroud; and
a heat shield plate that is disposed on an outer side of the fixed plate in the vane height direction and that is disposed to cover at least a part of the outer side shroud, wherein, in a case where a projection area in which the outer side shroud is projected to a plane orthogonal to the vane height direction is denoted by A, and a projection area in which the heat shield plate is projected to a plane orthogonal to the vane height direction is denoted by B, B/A≥0.40 is satisfied.

2. The gas turbine stator vane according to claim 1,
wherein, in a case where a dimension of an inlet of the passage in an axial direction of a gas turbine is denoted by C, the number of gas turbine stator vanes connected to the outer side shroud is denoted by N, and a dimension of the outer side shroud in a circumferential direction of the gas turbine is denoted by D, B≥C×D/N is satisfied.

3. The gas turbine stator vane according to claim 1,
wherein the outer side shroud includes
a bottom plate portion connected to the outer side end of the vane-shaped portion in the vane height direction, and
a peripheral wall portion formed along a peripheral edge of the bottom plate portion to protrude outward in the vane height direction from the peripheral edge, the heat shield plate is provided to cover at least a part of a part of the bottom plate portion surrounded by the peripheral wall portion, and
in a case where a projection area in which the part of the bottom plate portion surrounded by the peripheral wall portion is projected to a plane orthogonal to the vane height direction is denoted by E, B/E≥0.50 is satisfied.

4. The gas turbine stator vane according to claim 1,
wherein, in a case where a projection area in which a part of the outer side shroud excluding a hook for fixing the outer side shroud to a turbine casing is projected to a plane orthogonal to the vane height direction is denoted by F, B/F≥0.45 is satisfied.

5. The gas turbine stator vane according to claim 1,
wherein a dimension of the heat shield plate in an axial direction of a gas turbine is larger than a dimension of an inlet of the passage in the axial direction.

6. The gas turbine stator vane according to claim 1,
wherein a dimension of the heat shield plate in an axial direction of a gas turbine is larger than a dimension of the fixed plate in the axial direction.

7. The gas turbine stator vane according to claim 1,
wherein, in the heat shield plate, a distance between the heat shield plate and an upstream end of the outer side shroud in an axial direction of a gas turbine is smaller than a distance between an inlet of the passage and the upstream end of the outer side shroud in the axial direction, and a distance between the heat shield plate and a downstream end of the outer side shroud in the axial direction is smaller than a distance between the inlet and the downstream end of the outer side shroud in the axial direction.

8. The gas turbine stator vane according to claim 1,
wherein, in the heat shield plate, a distance between the heat shield plate and an upstream end of the outer side shroud in an axial direction of a gas turbine is smaller than a distance between the fixed plate and the upstream end of the outer side shroud in the axial direction, and a distance between the heat shield plate and a downstream end of the outer side shroud in the axial direction is smaller than a distance between the fixed plate and the downstream end of the outer side shroud in the axial direction.

9. The gas turbine stator vane according to claim 1,
wherein a gap is provided between the heat shield plate and the sealed tube.

10. The gas turbine stator vane according to claim 1,
wherein an impingement cooling hole for impingement cooling of the outer side shroud is not formed in the heat shield plate.

11. The gas turbine stator vane according to claim 1, further comprising:
a welded portion in which the heat shield plate and the outer side shroud are welded to each other along an end edge of a peripheral edge of the heat shield plate on an upstream side in an axial direction of a gas turbine;
a welded portion in which the heat shield plate and the outer side shroud are welded to each other along an end edge of the peripheral edge of the heat shield plate on a downstream side in the axial direction;
a welded portion in which the heat shield plate and the outer side shroud are welded to each other along an end edge of the peripheral edge of the heat shield plate on one side in a circumferential direction of the gas turbine; and
a welded portion in which the heat shield plate and the outer side shroud are welded to each other along an end edge of the peripheral edge of the heat shield plate on the other side in the circumferential direction.

12. The gas turbine stator vane according to claim 1, further comprising:
a welded portion in which the heat shield plate and the outer side shroud are welded to each other along an end edge of a peripheral edge of the heat shield plate on one side in a circumferential direction of a gas turbine; and
a welded portion in which the heat shield plate and the outer side shroud are welded to each other along an end edge of the peripheral edge of the heat shield plate on the other side in the circumferential direction,
wherein the gas turbine stator vane is not provided with
a welded portion in which the heat shield plate and the outer side shroud are welded to each other along an end edge of the peripheral edge of the heat shield plate on an upstream side in an axial direction of the gas turbine, and
a welded portion in which the heat shield plate and the outer side shroud are welded to each other along an end edge of the peripheral edge of the heat shield plate on a downstream side in the axial direction.

13. A gas turbine stator vane comprising:
a vane-shaped portion;
an outer side shroud connected to an outer side end of the vane-shaped portion in a vane height direction;
an inner side shroud connected to an inner side end of the vane-shaped portion in the vane height direction;
a passage passing through an inside of the vane-shaped portion to provide communication between an outer side cavity formed on an outer side of the outer side shroud in the vane height direction and an inner side cavity formed on an inner side of the inner side shroud in the vane height direction;
a sealed tube that is disposed in the passage and that is configured to guide air in the outer side cavity to the inner side cavity;
a fixed plate attached to the sealed tube and fixed to the inner side shroud; and
a heat shield plate that is disposed on an inner side of the fixed plate in the vane height direction and that is disposed to cover at least a part of the inner side shroud.

14. The gas turbine stator vane according to claim 13,
wherein a dimension of the heat shield plate in an axial direction of a gas turbine is larger than a dimension of an outlet of the passage in the axial direction.

15. The gas turbine stator vane according to claim 13,
wherein a dimension of the heat shield plate in an axial direction of a gas turbine is larger than a dimension of the fixed plate in the axial direction.

16. The gas turbine stator vane according to claim 13,
wherein, in the heat shield plate, a distance between the heat shield plate and an upstream end of the inner side shroud in an axial direction of a gas turbine is smaller than a distance between an outlet of the passage and the upstream end of the inner side shroud in the axial direction, and a distance between the heat shield plate and a downstream end of the inner side shroud in the axial direction is smaller than a distance between the outlet and the downstream end of the inner side shroud in the axial direction.

17. The gas turbine stator vane according to claim 13,
wherein, in the heat shield plate, a distance between the heat shield plate and an upstream end of the inner side shroud in an axial direction of a gas turbine is smaller than a distance between the fixed plate and the upstream end of the inner side shroud in the axial direction, and a distance between the heat shield plate and a downstream end of the inner side shroud in the axial direction is smaller than a distance between the fixed plate and the downstream end of the inner side shroud in the axial direction.

18. The gas turbine stator vane according to claim 13,
wherein a gap is provided between the heat shield plate and the sealed tube.

19. A gas turbine comprising:
the gas turbine stator vane according to claim 1;
a turbine rotor; and
a turbine casing accommodating the turbine rotor.
